(19) United States
(12) Patent Application Publication
(10) Pub. No.: US 2015/0231947 A1
(43) Pub. Date: Aug. 20, 2015

(54) SYSTEMS AND METHODS FOR VENTILATION

(71) Applicant: GM GLOBAL TECHNOLOGY OPERATIONS LLC, Detroit, MI (US)

(72) Inventors: YAEL SHMUELI-FRIEDLAND, TEL AVIV (IL); CLAUDIA V. GOLDMAN-SHENHAR, MEVASSERET ZION (IL)

(73) Assignee: GM GLOBAL TECHNOLOGY OPERATIONS LLC, Detroit, MI (US)

(21) Appl. No.: 14/181,830

(22) Filed: Feb. 17, 2014

(51) Int. Cl. B60H 1/00

(52) U.S. Cl. CPC B60H 1/00742; B60H 1/00842; B60H 1/00828

(57) ABSTRACT

Methods and apparatus are provided for ventilation in a vehicle. The method includes receiving data identifying a driver of the vehicle and retrieving a setting for one or more vents associated with the ventilation system of the vehicle based on the identified driver. The method further includes outputting one or more control signals to adjust the position of the one or more vents based on the setting.

### TECHNICAL FIELD

The present disclosure generally relates to vehicles and more particularly relates to systems and methods for ventilation in a vehicle.

### BACKGROUND

Most vehicles include a heating and cooling ventilation system. This system provides hot, warm or cool air to the occupants of the vehicle through one or more vents associated with the vehicle. Generally, in order to adjust the position of one or more of the vents to achieve a desired heating or cooling effect, the occupant(s) of the vehicle have to manually manipulate the selected one or more of the vents into a desired position. In certain instances, it may be difficult for the occupant(s) to adjust the position of the one or more vents. In this regard, the occupant(s) may not be able to reach the one or more vents or the adjustment of the one or more vents may interfere with the operation of the vehicle. In addition, the occupant(s) of the vehicle may be unaware if the ventilation system is set to a setting that may be inefficient for the ventilation system, which may increase energy consumption.

Accordingly, it is desirable to provide systems and methods for ventilation in a vehicle, which reduces energy consumption. Furthermore, other desirable features and characteristics of the present invention will become apparent from the subsequent detailed description and the appended claims, taken in conjunction with the accompanying drawings and the foregoing technical field and background.

### SUMMARY

In one embodiment, a method is provided for controlling a ventilation system in a vehicle. The method comprises receiving data identifying a driver of the vehicle and retrieving a setting for one or more vents associated with the ventilation system of the vehicle based on the identified driver. The method further comprises outputting one or more control signals to adjust the position of the one or more vents based on the setting.

In another embodiment, a ventilation system for a vehicle is provided. The system includes at least one vent having an opening and a plurality of guides positionable relative to the opening. The system also includes a source of occupant data that identifies a number of occupants in the vehicle and a source of driver data that identifies a driver of the vehicle. The system includes a control module that outputs one or more control signals to automatically adjust a position of the plurality of guides relative to the opening based on the occupant data and the driver data.

### DESCRIPTION OF THE DRAWINGS

The exemplary embodiments will hereinafter be described in conjunction with the following drawing figures, wherein like numerals denote like elements, and wherein:

FIG. 1 is a functional block diagram illustrating a vehicle that includes a ventilation system in accordance with various embodiments;

FIG. 2A is a perspective environmental view of an exemplary vent of the ventilation system in a first position according to various embodiments;

FIG. 2B is a perspective environmental view of an exemplary vent of the ventilation system in a second position according to various embodiments;

FIG. 2C is a perspective environmental view of an exemplary vent of the ventilation system in a third position according to various embodiments;

FIG. 3 is a dataflow diagram illustrating a control system of the ventilation system in accordance with various embodiments; and

FIG. 4 is a flowchart illustrating a control method of the ventilation system in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

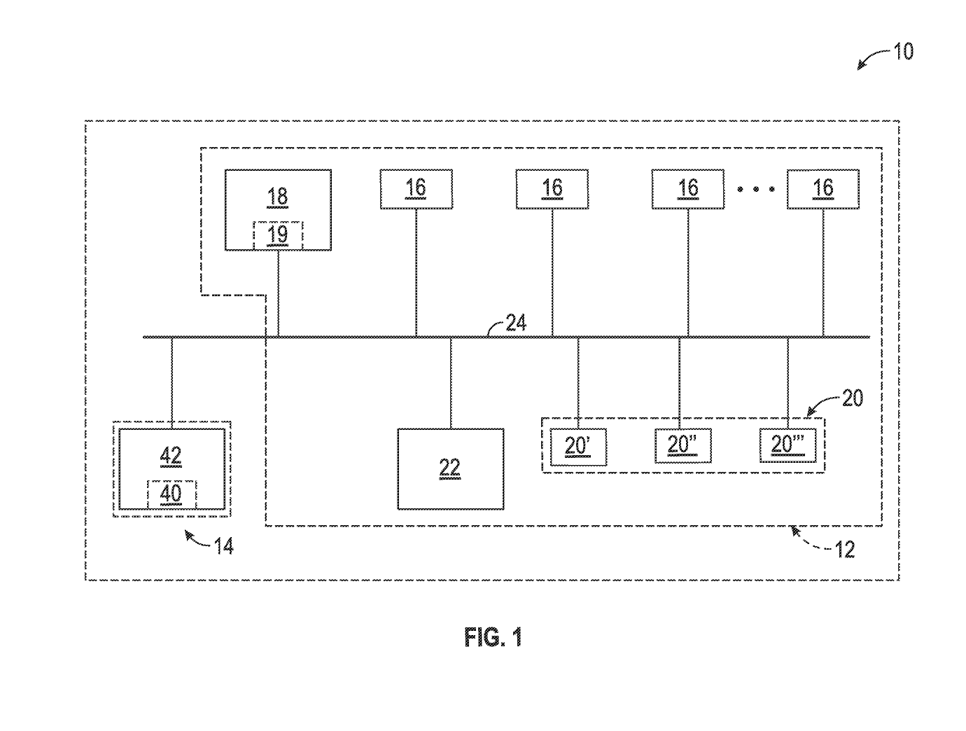

With reference to FIG. 1, a vehicle 10 includes a ventilation system 12 and a human-machine interface 14. The ventilation system 12 supplies heated or cooled air to one or more occupants of the vehicle 10. In one example, the ventilation system 12 includes one or more vents 16, a fan 18, one or more sensors 20 and a control module 22. Each of the vents 16, the fan 18 and the sensors 20 are in communication with the control module 22 and the human-machine interface 14 over an interconnection architecture 24, or arrangement that facilitates transfer of data, commands, power, etc. The ventilation system 12 can also include a source or supply of heated or cooled air, along with the required ducting to supply the heated or cooled air to the fan 18 and from the fan 18 to the vents 16, as known to one of skilled in the art. Thus, it should be noted that the ventilation system 12 described herein is merely exemplary, as the ventilation system 12 may include any number of components.

As will be discussed in greater detail herein, the control module 22 controls the operation of the fan 18 and a position associated with the vents 16 based on a setting associated with a driver of the vehicle 10 and a number of occupants of the vehicle 10. As can be appreciated, the control module 22 can alternatively be implemented as multiple control modules (not shown), one for each vent 16 and fan 18. For exemplary purposes, the control module 22 will be discussed as a single control module 22 that controls the multiple vents 16 and the fan 18. In one example, the control module 22 controls the multiple vents 16 and fan 18 when the ventilation system 12 is operating in an automatic mode or a mode in which the control module 22 automatically controls the climate within the cabin of the vehicle 10 based on a user desired temperature, which may be input by the user through the human-machine interface 14.

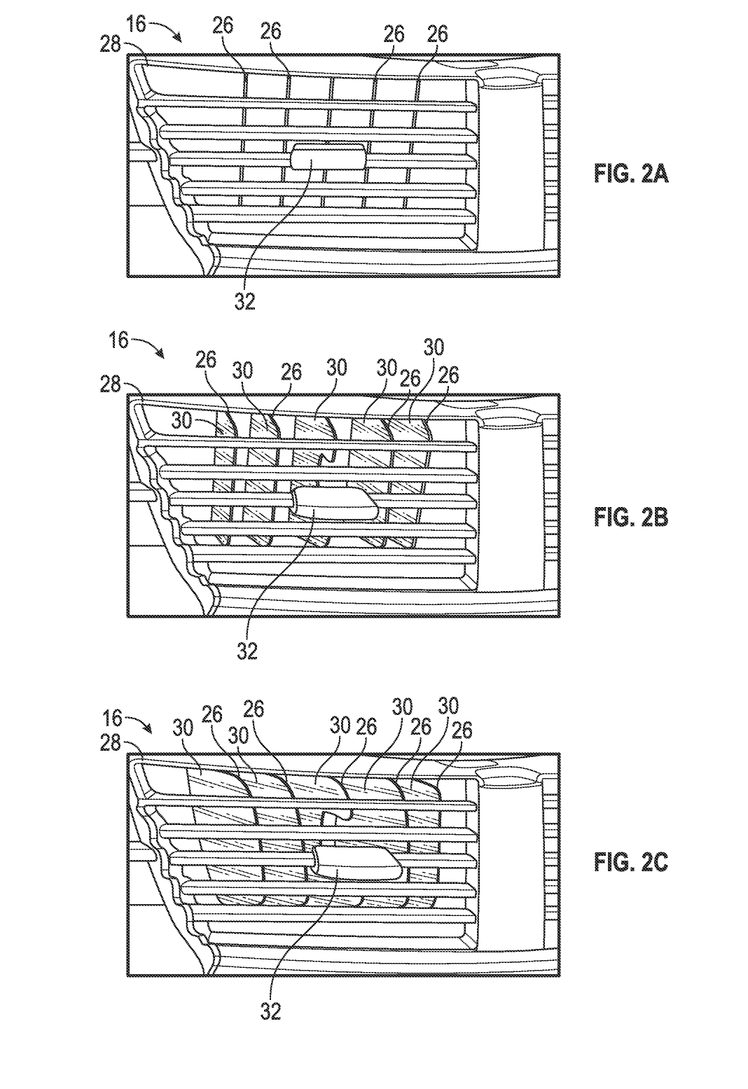

With continued reference to FIG. 1, and with reference to FIGS. 2A-2C, the one or more vents 16 are positioned in a cabin of the vehicle 10, and each include a plurality of guides 26 for directing air into the cabin. The vents 16 may be spaced apart within the cabin or may be grouped. In other words, the vents 16 may have any suitable or desired configuration within the cabin. In one example, the vents 16 include four vents 16 (FIG. 1), however, the vents 16 may include any number of vents. The vents 16 may be positioned to direct air into any desired portion of the cabin, and thus, the vents 16 may be located at any desired position within the cabin, including, but not limited to, an instrument panel, on or near a floorboard of the cabin, on or near a headliner of the cabin, near one or more rear rows of seating in the cabin, etc. Each of the vents 16 is responsive to one or more control signals from the control module 22 to adjust a position of the guides 26 to alter the direction of the flow of air into the cabin. In one example, each of the vents 16 comprises a smart material that is responsive to an electrical current to adjust the position of the guides 26. In other examples, any suitable device may be employed to alter the position of the guides 26 of each of the vents 16 based on one or more control signals from the control module 22, including, but not limited to, an electric motor (not shown) mechanically coupled to the guides 26 and responsive to the one or more control signals from the control module 22 to move the guides 26.

With reference to FIGS. 2A-2C, the guides 26 of each of the vents 16 are movable between any number of positions. For example, as shown, the guides 26 are movable between three positions, including, but not limited to, about 45° relative to an opening 28 of the vent 16 (FIG. 2A), about 90° relative to the opening 28 of the vent 16 (FIG. 2B) and about 135° relative to the opening 28 (FIG. 2C). In one example, at least one of the guides 26 includes a visual indicator 30 (FIGS. 2B and 2C). The visual indicator 30 provides a visual notification to occupants of the vehicle 10 of the position of the guides 26. The visual indicator 30 includes, but is not limited to, a colored coating and/or at least one light emitting diode (LED).

In addition, each of the vents 16 may include a source of user input, including, but not limited to, a slide 32. It should be noted that the use of the slide 32 is merely exemplary, as one or more of the vents 16 may be responsive to other types of user input devices, including, but not limited to a button, speech recognition, gesture recognition, etc. to adjust a position of the guides 26. In this example, the slide 32 enables the occupants of the vehicle 10 to manually adjust the position of the guides 26. For example, the slide 32 may be coupled to the guides 26 associated with the respective one of the vents 16 such that user input to the slide 32 moves the guides 26 to a desired location. The movement of the slide 32 or the movement of the guides 26 may be observed by a sensor, which generates one or more position signals indicating a position of the guides 26 relative to the opening 28 and communicates the one or more position signals to the control module 22. As will be discussed, the one or more position signals received based on user input to the one or more vents 16 may be stored by the control module 22 for future use, for example, as a setting for the operation of the ventilation system 12.

With reference back to FIG. 1, the fan 18 is in communication with the vents 16, and outputs an amount of air to the vents 16. The fan 18 comprises any suitable fan or blower that provides air output at adjustable amounts for the vents 16. The fan 18 includes a motor 19. The fan 18 is responsive to one or more control signals from the control module 22 to change a speed of the motor 19, and thereby, change an output volume of air from the fan 18. The motor 19 may operate at a variety of speeds, including, but not limited to, high and low. As will be discussed herein, adjusting the speed of the motor 19 of the fan 18 with the control module 22 may reduce energy consumed by the fan 18.

The one or more sensors 20 observe conditions of the ventilation system 12 and/or the vehicle 10 and generate sensor signals based on the observed conditions. In one example, the sensors 20 include a cabin temperature sensor 20′, an outside or external temperature sensor 20″ and may also include a motor speed sensor 20′″ that observes a speed of the motor 19 of the fan 18. It should be noted that the sensors 20′, 20″, 20′″ are merely exemplary, as any number of sensors 20 could be employed and further, one or more of the conditions measured by the sensors 20′, 20″, 20′″ can be derived from other sources, such as by modeling, for example.

In various embodiments, the control module 22 controls the operation of the ventilation system 12 based on one or more of the sensor signals, inputs received from other modules associated with the vehicle 10, inputs received from one or more of the vents 16, inputs received from the human-machine interface 14 and methods of the present disclosure. In one example, the control module 22 generates one or more control signals to adjust a position of the guides 26 of one or more of the vents 16 based on at least one of the driver of the vehicle, the number of occupants in the vehicle, the cabin temperature, the external temperature and combinations thereof. In another example, the control module 22 generates one or more control signals to change or adjust the position of the guides 26 of one or more of the vents 16 based on a user defined setting stored in response to the position signal from the slide 32 associated with one or more of the vents 16. In another example, the control module 22 may generate one or more control signals to change or adjust a speed of a motor 19 of the fan 18 based on a response received from a user, which may reduce energy consumption in the vehicle 10. The adjustment of the guides 26 of the vents 16 by the control module 22 optimizes the flow of air from the ventilation system 12 to the occupants of the vehicle 10, which improves the operation of the ventilation system 12, thereby increasing occupant satisfaction with the vehicle 10.

The human-machine interface 14 enables the operator or an occupant of the vehicle 10 to interface with the ventilation system 12 of the vehicle 10. The human-machine interface 14 is associated with a user input device 40 and a display 42. The user input device 40 is any suitable device capable of receiving user input, including, but not limited to, a keyboard, one or more knobs, one or more buttons, one or more sliders, a camera with gesture recognition capabilities, a microphone, a touchscreen layer associated with the display 42, or other suitable device to receive data and/or commands from the user. Of course, multiple user input devices 40 can also be utilized. The display 42 comprises any suitable technology for displaying information, including, but not limited to, a liquid crystal display (LCD), organic light emitting diode (OLED), plasma, or a cathode ray tube (CRT). The user input received by the user input device 40 enables the user to customize the performance of the ventilation system 12, as will be discussed in greater detail herein. It should be noted that the user input device 40 and the display 42 can be implemented as part of an infotainment system or other system associated with the vehicle 10.

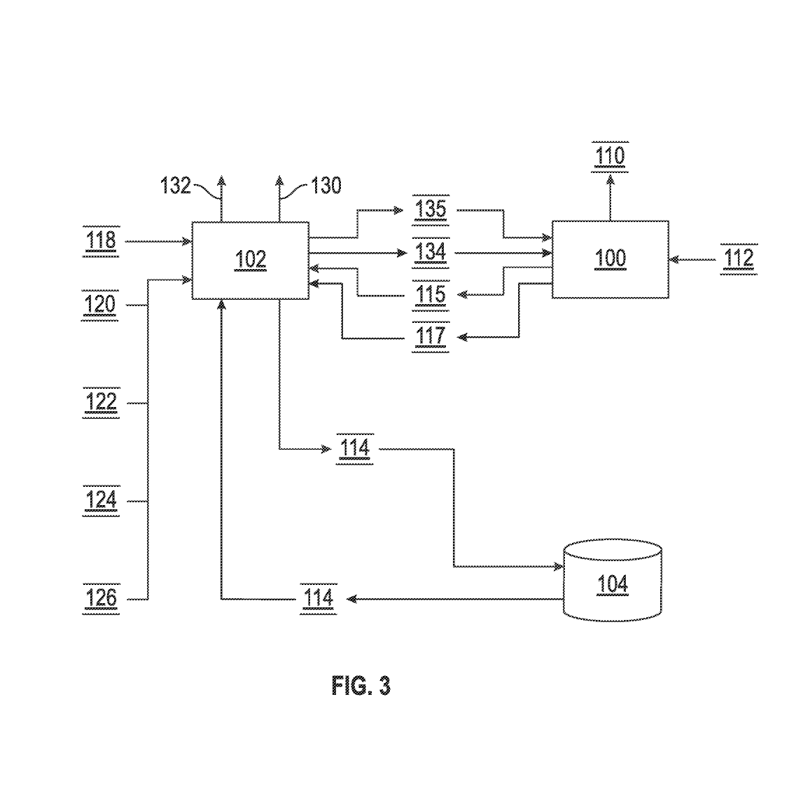

Referring now to FIG. 3 and with continued reference to FIG. 1, a dataflow diagram illustrates various embodiments of the control module 22 of the ventilation system 12. Various embodiments of the control module 22 according to the present disclosure can include any number of sub-modules embedded within the control module 22. As can be appreciated, the sub-modules shown in FIG. 3 can be combined and/or further partitioned to similarly generate control signals to one or more of the vents 16 and/or the motor 19 of the fan 18 of the vehicle 10. Inputs to the control module 22 may be sensed from the vehicle 10 (FIG. 1), received from other control modules (not shown) within the vehicle 10, and/or determined/modeled by other sub-modules (not shown) within the control module 22. In various embodiments, the control module 22 includes a user interface (UI) control module 100, a ventilation control module 102 and a tables datastore 104.

The tables datastore 104 stores one or more tables (e.g., lookup tables) that indicate a rule, setting or position for each of the vents 16 based on various parameters. In various embodiments, the tables can be interpolation tables that are defined by one or more indexes. The position for the guides 26 for each of the vents 16 provided by at least one of the tables indicates a position for each of the guides 26 of the respective vents 16 relative to the opening 28 of each of the vents 16, such as about 45°, about 90° or about 135°. In one example, one or more tables can be indexed by parameters such as, but not limited to, a heating or cooling operation of the ventilation system 12, fan speed, requested air flow direction (towards the feet of the occupants or outwardly towards the occupants), the driver and the number of passengers, and can provide a position for each of the vents 16. In various embodiments, one or more of the positions for the guides 26 of each of the vents 16 are predefined (e.g., factory set); and one or more of the positions for the guides 26 of each of the vents 16 are user-configured. As can be appreciated, the tables datastore 104 can be any non-volatile memory type that stores the information over the repeated use of the vehicle 10. Further, while the tables datastore 104 is illustrated as being associated with the control module 22 of the vehicle 10, it should be noted that the tables datastore 104 can be located remote from the vehicle 10 and accessed through a suitable wired or wireless interface, as known to one skilled in the art.

The UI control module 100 generates user interface data 110 that may be used by the display 42 to display a user interface of the human-machine interface 14 (FIG. 1) that may include a prompt 134 for saving a particular position of the vents 16 as a user defined configuration or setting and/or a prompt 135 for adjusting a speed of the motor 19 of the fan 18. For example, the prompt 134 can comprise a selectable item and/or text input item for selecting the current position of the vents 16 as a user defined setting for a particular driver of the vehicle 10. The prompt 135 can comprise a selectable item and/or text input item for adjusting or reducing a speed of the motor 19 of the fan 18.

The UI control module 100 receives as input user input data 112 based on a user's interaction with the human-machine interface 14 (FIG. 1), such as the user's interaction with the prompt 134 and/or prompt 135. The user input data 112 comprises a response 115 to the prompt 134 and a response 117 to the prompt 135. The UI control module 100 interprets and provides the response 115 and the response 117 for the ventilation control module 102. The UI control module 100 may also receive as user input data 112 based on the user's interaction with the human-machine interface 14 (FIG. 1), a request to operate the ventilation system 12 in the automatic mode.

The ventilation control module 102 receives as input sensor data 118, for example, from the sensors 20 of the ventilation system 12, along with driver data 120, occupant data 122 and fan speed data 124. In one example, the sensor data 118 comprises an outside or external temperature received from the sensor 20″ and a temperature of the cabin of the vehicle 10 received from the sensor 20′. The driver data 120 comprises an identification of the driver of the vehicle 10. The identification of the driver may be based on biometric data, a key fob employed to start the vehicle 10, seat position data, or any suitable system or method for identifying a particular driver of the vehicle 10. The occupant data 122 comprises the number of occupants in the vehicle 10, and may be based on data received from other modules or devices associated with the vehicle 10, including, but not limited to, a seatbelt latch sensor, one or more occupant sensors, and/or one or more seat pressure sensors. The fan speed data 124 comprises a current operating speed of the motor 19 of the fan 18 (e.g. low or high), which may be received from the motor speed sensor 20″.

The ventilation control module 102 retrieves from the tables datastore 104, a rule or setting 114 for the position of the guides 26 of each of the vents 16 based on the sensor data 118, the driver data 120, the occupant data 122 and the fan speed data 124. The ventilation control module 102 outputs one or more control signals 130 to one or more of the vents 16 to automatically adjust a position of the guides 26 to the position identified in the setting 114 based on the setting 114.

In addition, based on the setting 114 and the sensor data 118, the ventilation control module 102 sets the prompt 135 for the UI control module 100. According to various embodiments, the ventilation control module 102 receives as input the response 117 to the prompt 135. Based on the response 117 and the fan speed data 124, the ventilation control module 102 outputs one or more control signals 132 to the fan 18 to adjust a speed of the motor 19 of the fan 18.

In various embodiments, the ventilation control module 102 also receives as input vent data 126 and the response 115. The vent data 126 comprises a manual adjustment or a manually selected position of one or more of the vents 16 based on user input to the slide 32. In other words, the vent data 126 comprises one or more position signals received from the slides 32 of the vents 16. Based on the vent data 126, the ventilation control module 102 sets the prompt 134 for the UI control module 100. The ventilation control module 102 updates the tables datastore 104 to include the vent data 126 as the setting 114 associated with the driver identified in the driver data 120 based on the response 115.

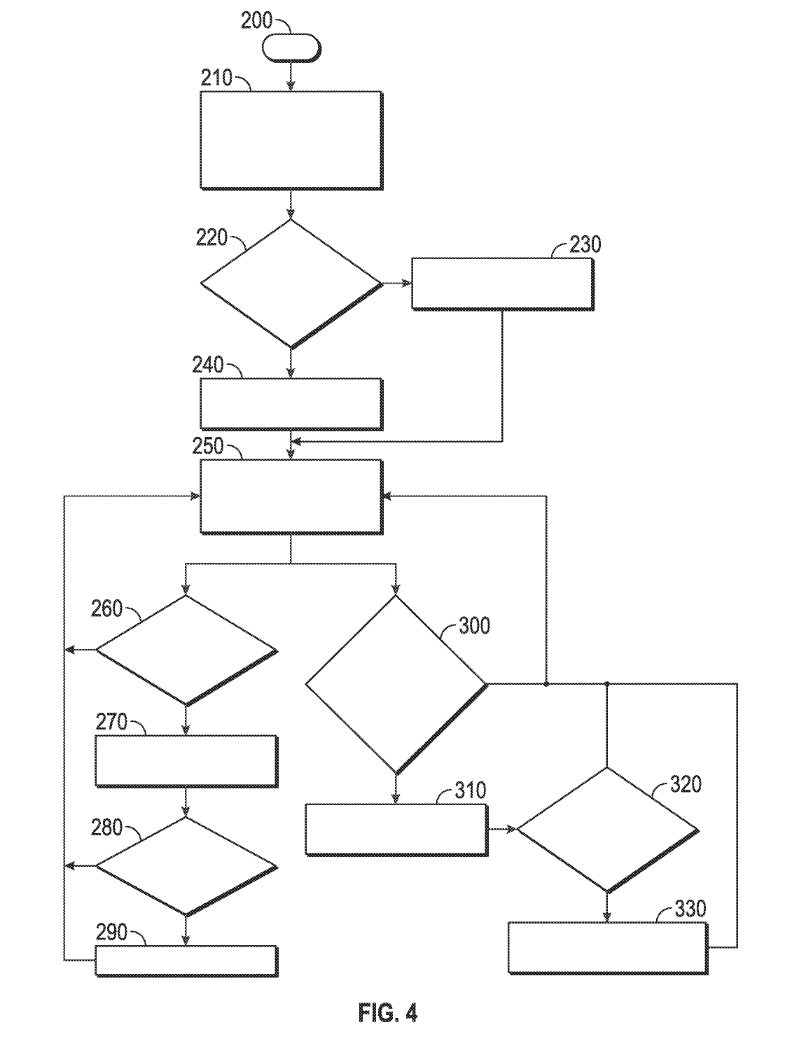

Referring now to FIG. 4, and with continued reference to FIGS. 1-3, a flowchart illustrates a control method that can be performed by the control module 22 in accordance with the present disclosure. As can be appreciated in light of the disclosure, the order of operation within the method is not limited to the sequential execution as illustrated in FIG. 4, but may be performed in one or more varying orders as applicable and in accordance with the present disclosure. As can further be appreciated, one or more steps of the method may be added or removed without altering the spirit of the method.

The method may begin at 200. It should be noted that although the method is described herein as applying to all vents 16, the method may apply to a subset of vents 16 within the cabin, such as, to a subset of vents 16 located in an instrument panel associated with the vehicle 10. Generally, the method runs substantially continuously during the operation of the vehicle 10, however, the method may run during predefined time periods or as desired by the user.

At 210, sensor data 118, driver data 120, occupant data 122 and fan speed data 124 are received. At 220, the method queries the tables datastore 104 based on the driver data 120, to determine if a rule or setting 114 is associated with the identified driver. If a setting 114 is associated with the identified driver, then the method retrieves the setting 114 from the tables datastore 104 at 230. Otherwise, at 240, the method retrieves the default rule or setting 114, such as a factory setting. At 250, the method outputs one or more control signals 130 to adjust the guides 26 of one or of the vents 16 based on the occupant data 122 and the retrieved setting 114. In one embodiment, the method may output one or more control signals to illuminate the visual indicator 30 associated with the one or more vents 16 to indicate the position of the guides 26 of the one or more vents 16.

At 260, the method determines if a user has adjusted the guides 26 of one or more of the vents 16 based on user input to the slide 32. If the user has not adjusted one or more of the vents 16, then the method goes to 250. Otherwise, if the user has adjusted one or more of the vents 16, at 270, the method outputs prompt 134 for the user for saving the user-defined position of one or more of the vents 16 as the setting 114. At 280, the method determines if the response 115 has been received that the user would like to save the user defined position as the setting 114. If the user selects to save the user defined position of the one or more vents 16 as the setting 114, then the method at 290, updates the tables datastore 104 with the new setting 114 for the driver identified in the driver data 120. Otherwise, if the user does not want to save the user defined position of the one or more vents 16 as the setting 114, the method loops to 250.

At 300, the method determines, based on the sensor data 118 and the fan speed data 124 if the speed of the motor 19 of the fan 18 should be changed to conserve energy. In one embodiment, if the difference between the external temperature from the sensor 20″ and the temperature of the cabin from the sensor 20′ is less than an acceptable difference, such as about 2 degrees, the speed of the motor 19 of the fan 18 is high and the output of the fan 18 is directed towards the vents 16 located in the instrument panel of the vehicle 10, then at 310, the method outputs prompt 135 for the user for adjusting or reducing a speed of the motor 19 of the fan 18. In another embodiment, the method may determine to output the prompt 135 based on the temperature in the cabin reaching a user-selected desired temperature within a predefined limit.

At 320, the method determines if the response 117 has been received that the user would like to adjust or reduce the speed of the motor 19 of the fan 18. If no response 117 is received, the method loops to 250. If the user selects to adjust or reduce the speed of the motor 19 of the fan 18, then at 330, the method outputs the one or more control signals 132 to change the speed of the motor 19 of the fan 18. Then, the method loops to 250. Otherwise, at 300, if the method determines not to output the prompt 135, then the method loops to 250. It should be noted that while the method is illustrated such that the method performs blocks 260 and 300 substantially simultaneously, this is merely exemplary.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the appended claims and the legal equivalents thereof.

What is claimed is:

1. A method of controlling a ventilation system of a vehicle, comprising:
receiving data identifying a driver of the vehicle;
retrieving a setting for one or more vents associated with the ventilation system of the vehicle based on the identified driver; and
outputting one or more control signals to adjust the position of the one or more vents based on the setting.

2. The method of claim 1, wherein the position of the one or more vents comprises a position of one or more guides within an opening of each respective one of the one or more vents.

3. The method of claim 2, wherein the setting is user-defined.

4. The method of claim 3, further comprising:
receiving at least one position signal from one or more slides coupled to the one or more guides of one of the one or more vents that indicates a position of the one or more guides within the respective one of the one or more vents; and
outputting a prompt to save the position received in the at least one position signal as the setting.

5. The method of claim 4, further comprising:
receiving a response to the prompt; and
updating a datastore with the setting based on the response.

6. The method of claim 1, further comprising:
receiving sensor data identifying a number of occupants in the vehicle,
wherein the setting for the position of the one or more vents associated with the ventilation system of the vehicle is based on the identified driver and the number of occupants in the vehicle.

7. The method of claim 1, further comprising:
receiving sensor data identifying at least a temperature of a cabin of the vehicle; and
outputting a prompt to adjust a speed of a motor of a fan associated with the ventilation system.

8. A ventilation system for a vehicle, comprising:
at least one vent having an opening and a plurality of guides that are positionable relative to the opening;
a source of occupant data that identifies a number of occupants in the vehicle;
a source of driver data that identifies a driver of the vehicle; and
a control module that generates one or more control signals that automatically adjusts a position of the plurality of guides relative to the opening based on the occupant data and the driver data.

9. The system of claim 8, wherein the one or more control signals automatically adjust the plurality of guides to a position of about 45°, about 90° or about 135° relative to the opening of the at least one vent.

10. The system of claim 8, wherein based on the occupant data and the driver data, the control module accesses a datastore to retrieve a setting for the position of the plurality of guides of the at least one vent, and outputs the one or more control signals based on the setting.

11. The system of claim 8, wherein at least one of the plurality of guides includes a visual indicator to indicate the position of the plurality of guides relative to the opening.

12. The system of claim 8, further comprising:
a fan in communication with the at least one vent for supplying air to the at least one vent and having a motor operable at a plurality of speeds for adjusting an air output through the at least one vent; and
at least one sensor that observes a temperature of a passenger cabin of the vehicle,
wherein the control module outputs a prompt to adjust a speed of the motor of the fan based on the temperature of the passenger cabin.

13. The system of claim 10, wherein the at least one vent further comprises a slide coupled to the plurality of guides, the slide responsive to a user input to manually adjust the position of the plurality of guides relative to the opening.

14. The system of claim 13, further comprising:
a user interface including a display device and at least one user input device,
wherein the control module outputs a prompt on the display device in response to the user input to manually adjust the position of the plurality of guides.

15. The system of claim 14, wherein, based on a response received through the at least one user input device, the control module saves the manually adjusted position of the plurality of guides as the setting in the datastore.

16. A vehicle, comprising:
at least one vent having an opening and a plurality of guides positionable relative to the opening, the at least one vent including a slide coupled to the plurality of guides, the slide responsive to a user input to manually adjust the position of the plurality of guides relative to the opening;
a user interface including a display and at least one user input device;
a source of occupant data that identifies a number of occupants in the vehicle;
a source of driver data that identifies a driver of the vehicle; and
a control module that:
accesses a datastore to retrieve a setting for the position of the plurality of guides based on the occupant data and the driver data;
outputs one or more control signals to automatically adjust a position of the plurality of guides relative to the opening based on the setting;
outputs a prompt to the display based on the receipt of manual input to the slide that adjusts the position of the plurality of guides relative to the opening; and
based on a response to the prompt, saves the manual input to the slide as the setting.

17. The vehicle of claim 16, wherein the one or more control signals automatically adjusts the plurality of guides to a position of about 45°, about 90° or about 135° relative to the opening of the at least one vent.

18. The vehicle of claim 16, wherein at least one of the plurality of guides includes a visual indicator to indicate the position of the plurality of guides relative to the opening.

19. The vehicle of claim 16, further comprising:
a fan in communication with the at least one vent for supplying air to the at least one vent and having a motor operable at a plurality of speeds for adjusting an air output through the at least one vent;
at least one sensor that observes a temperature of a passenger cabin of the vehicle; and
at least one sensor that observes a temperature outside of the vehicle,
wherein the control module outputs a prompt to adjust a speed of the motor of the fan based on the temperature of the passenger cabin and the temperature outside of the vehicle.

20. The vehicle of claim 16, wherein the at least one vent comprises a plurality of vents each having a plurality of guides and an opening, and the setting includes a position for each of the plurality of guides for each of the plurality of vents relative to the opening of each respective vent of the plurality of vents.
